(19) United States
(12) Patent Application Publication
(10) Pub. No.: US 2008/0251106 A1
(43) Pub. Date: Oct. 16, 2008

(54) Process of cleaning a hard surface with zwitterionic copolymer

(76) Inventors: Stefano Scialla, Rome (IT); Oreste Todini, Brussel (BE); Marc Francois Theophile Evers, Strombeek-Bever (BE); Mercedes Labiano Ros, Zaragoza (ES); Robby Renilde Francois Keuleers, Lippelo (BE); Vincenzo Tomarchio, Brussels (BE)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 11/786,619

(22) Filed: Apr. 12, 2007

(51) Int. Cl. B08B 3/08

(52) U.S. Cl. 134/42

(57) ABSTRACT

The present invention relates to a process of cleaning a hard surface with a composition comprising a specific water-soluble or water-dispersible copolymer, said process comprises the steps of applying said composition onto said surface in diluted form and leaving said diluted composition to dry on said surface without rinsing said surface.

### FIELD OF THE INVENTION

The present invention relates to a process of cleaning a hard surface with a composition comprising a zwitterionic polymer of defined structure. More specifically it relates to a process of cleaning a hard surface in a so called dilute/no rinse application, wherein a composition comprising the zwitterionic polymer herein is applied onto said hard surface in its diluted form and is left to dry on said hard surface.

### BACKGROUND OF THE INVENTION

Manufacturers of hard surface cleaning compositions are continuously searching for new components that will improve the effectiveness of the compositions. The present invention relates to a new ingredient for use in cleaning of hard surfaces such as floors, tiles, work surfaces, ceramic surfaces, windows, blinds, shades, mirrors, household appliances, etc. in a so called dilute/no rinse hard surface cleaning application.

In such a dilute/no rinse hard surface cleaning application wherein a hard surface cleaning composition is applied onto a hard surface in its diluted form an left to dry on said hard surface without rinsing said surface, the resulting appearance of the hard surface after the dilute/no rinse hard surface cleaning application is of high relevance. Indeed, such a dilute/no rinse hard surface cleaning application has not only to provide a clean surface but the hard surface should also not show any visible filming and/or streaking. Furthermore, the hard surface should have a shiny appearance. In addition, providing the hard surface with soil repellency properties, meaning the prevention or at least reduction of deposition of soil after an initial cleaning operation, is a desired property. Moreover, providing a next time cleaning benefit, wherein the subsequent cleaning of an initially cleaned surface is facilitated, is a desired feature in such a dilute/no rinse hard surface cleaning application.

It has been found that the performance with regard to filming and/or streaking as well as to shine of compositions used in dilute/no rinse hard surface cleaning application may be improved. Furthermore, it has been found that the performance with regard to soil repellency and next time cleaning of compositions used in dilute/no rinse hard surface cleaning application may be improved.

Thus, the objective of the present invention is to provide a process of cleaning a hard surface with a liquid composition exhibiting good filming and/or streaking performance, good shine performance, good soil repellency performance as well as good next time cleaning benefit performance.

It has now been found that this objective can be met by a process of cleaning a hard surface with a liquid composition as described herein.

Advantageously, the process as described herein provides good cleaning performance.

A further advantage of the present invention is that the process herein may be used to clean hard surfaces made of a variety of materials like glazed and non-glazed ceramic tiles, enamel, stainless steel, Inox®, Formica®, vinyl, no-wax vinyl, linoleum, melamine, glass, plastics and plastified wood.

### SUMMARY OF THE INVENTION

The present invention relates to a process of cleaning a hard surface with a liquid composition comprising a water-soluble or water-dispersible copolymer as described herein below, said process comprises the steps of applying said composition onto said surface in diluted form and leaving said diluted composition to dry on said surface without rinsing said surface.

In an alternative embodiment, the present invention also encompasses the use of a water-soluble or water-dispersible copolymer herein in a process of cleaning a hard surface with a liquid composition comprising the water-soluble or water-dispersible copolymer as described herein below wherein the process comprises the step of applying said composition in its neat form onto said hard surface, wherein good filming and/or streaking performance as well as good shine performance is achieved.

### DETAILED DESCRIPTION OF THE INVENTION

### The Process of Cleaning a Hard Surface

The present invention encompasses a process of cleaning a hard surface with a liquid composition as described herein. In particular, the present invention encompasses a process of cleaning a hard surface with a liquid composition comprising the water-soluble or water-dispersible copolymer as described herein, said process comprises the steps of applying said composition onto said surface in diluted form and leaving said diluted composition to dry on said surface without rinsing said surface.

By “hard surface”, it is meant herein any kind of surface typically found in houses like kitchens, bathrooms, e.g., floors, walls, tiles, windows, cupboards, sinks, showers, shower plastified curtains, wash basins, WCs, dishes, fixtures and fittings and the like made of different materials like ceramic, vinyl, no-wax vinyl, linoleum, melamine, glass, Inox®, Formica®, any plastics, plastified wood, metal or any painted or varnished or sealed surface and the like. Hard-surfaces also include household appliances including, but not limited to refrigerators, freezers, washing machines, automatic dryers, ovens, microwave ovens, dishwashers and so on.

In a preferred embodiment according to the present invention, the hard surface to be cleaned in the process herein is a floor. Preferably, the hard surface to be cleaned in the process herein is selected from the group consisting of ceramic surfaces.

The composition herein is applied in its diluted form. By “diluted form”, it is meant herein that said liquid composition is diluted by the user with an appropriate solvent, typically with water. The composition is diluted prior to use to a typical dilution level of about 10 to about 400 times its weight of water, preferably from about 10 to about 200 and more preferably from about 10 to about 100. A usually recommended dilution level is about a 1.2% dilution of the composition in water. Dilution may occur immediately prior to the application of the composition herein onto the hard surface to be cleaned, e.g., in an appropriate receptacle such as a bucket, wherein an effective amount of liquid composition herein is mixed with water. In a preferred embodiment, the process herein comprises the additional step of diluting said composition with an appropriate solvent, preferably with water, before applying said composition in diluted form onto said hard surface.

In the process herein, said composition is applied onto said surface by conventional means known by the skilled person. Indeed, the composition may be applied by pouring or spraying said composition onto said surface. Alternatively, said composition may be applied using an appropriate implement, such as a mop or a cloth, soaked in the diluted composition herein. Furthermore, once applied onto said surface said composition may be agitated over said surface using an appropriate implement. Indeed, said surface may be wiped using a mop or a cloth. During such a cleaning operation parts of the composition herein may be captured in the cleaning implement, if any, (preferably in combination with soil initially present on the surface) and transferred into a bucket or another suitable receptacle (squeezing of the mop or cloth), another part of the composition will be left on the surface after the cleaning operation. Indeed, the composition is, preferably at least partially, left on said surface at the end of said process of cleaning said hard surface, more preferably left on said surface until the next cleaning operation and still more preferably at least partially left on said surface until the next cleaning operation.

However, in the process of cleaning a hard surface according to the present invention, the composition is applied onto said surface in diluted form without rinsing said hard surface after application. Indeed, the composition is (at least partially) left to dry on said hard surface.

By “rinsing”, it is meant herein contacting the hard surface cleaned with the process according to the present invention with substantial quantities of appropriate solvent, typically water, directly after the step of applying the liquid composition herein onto said hard surface. By “substantial quantities”, it is meant herein between about 0.01 lt. and about 1 lt. of water per m² of hard surface, more preferably between about 0.1 lt. and about 1 lt. of water per m² of hard surface.

However, the hard surface cleaned with the process according to the present invention may eventually be rinsed during a subsequent cleaning process. Furthermore, due to normal use of the hard surfaces cleaned by the process herein, said hard surfaces may eventually be wetted, by for example by spilling water or other liquids onto said surface. Such subsequent cleaning processes or the accidental wetting of the hard surface shall not be considered as rinsing of the surface within the meaning of the present invention. Moreover, the removal of parts of the composition applied onto the hard surface during the cleaning, e.g., by means of squeezing soiled composition out of a mop or cloth shall not be considered as rinsing of the surface within the meaning of the present invention.

The hard surfaces to be treated may be soiled with a variety of soils, e.g., greasy soils (e.g., greasy soap scum, body grease, kitchen grease or burnt/sticky food residues typically found in a kitchen and the like), particulate greasy soils or so called “limescale-containing stains”. By “limescale-containing stains” it is meant herein any pure limescale stains, i.e., any stains composed essentially of mineral deposits, as well as limescale-containing stains, i.e., stains which contain not only mineral deposits like calcium and/or magnesium carbonate but also soap scum (e.g., calcium stearate) and other grease (e.g. body grease).

### Liquid Composition

The composition used in the process according to the present invention is formulated as a liquid composition.

Preferred compositions herein have a viscosity of about 1 cps or greater, more preferably of from about 1 to about 20000 cps, and still more preferably of from about 1 to about 500 cps at 20° C. when measured with a CSL² 100® Rheometer at 20° C. with a 4 cm spindle (linear increment from 10 to 100 dyne/cm² in 2 minutes).

A preferred composition herein is an aqueous composition and therefore, preferably comprises water more preferably in an amount of from about 50% to about 98%, even more preferably of from about 75% to about 97% and most preferably about 80% to about 97% by weight of the total composition.

The pH of the liquid composition according to the present invention may typically be from about 0 to about 14.

In a preferred embodiment, the pH range is from about 7 to about 14, preferably from about 7.1 to about 14, more preferably from about 7.1 to about 13, even more preferably from about 7.1 to about 12 and most preferably from about 8.0 to about 10. Indeed, it has been surprisingly found that the greasy cleaning performance is further improved at these preferred alkaline to neutral pH ranges, preferably alkaline pH ranges. Accordingly, the compositions herein may further comprise an acid or base to adjust pH as appropriate.

A suitable acid for use herein is an organic and/or an inorganic acid. A preferred organic acid for use herein has a pKa of less than about 6. A suitable organic acid is selected from the group consisting of citric acid, lactic acid, glycolic acid, succinic acid, glutaric acid and adipic acid and a mixture thereof. A mixture of said acids may be commercially available from BASF under the trade name Sokalan® DCS. A suitable inorganic acid is selected from the group consisting hydrochloric acid, sulphuric acid, phosphoric acid and a mixture thereof.

A typical level of such an acid, when present, is of from about 0.01% to about 5.0%, preferably from about 0.04% to about 3.0% and more preferably from about 0.05% to about 1.5% by weight of the total composition.

A suitable base to be used herein is an organic and/or inorganic base. Suitable bases for use herein are the caustic alkalis, such as sodium hydroxide, potassium hydroxide and/or lithium hydroxide, and/or the alkali metal oxides such, as sodium and/or potassium oxide or mixtures thereof. A preferred base is a caustic alkali, more preferably sodium hydroxide and/or potassium hydroxide.

Other suitable bases include ammonia, ammonium carbonate, K₂CO₃, Na₂CO₃ and alkanolamines (as e.g. monoethanolamine).

Typical levels of such bases, when present, are of from about 0.01% to about 5.0%, preferably from about 0.05% to about 3.0% and more preferably from about 0.1% to about 0.6% by weight of the total composition.

### Water-Soluble or Water-Dispersible Copolymer

The water-soluble or water-dispersible copolymer herein is either a water-soluble or water-dispersible copolymer I as described herein below or a water-soluble or water-dispersible copolymer II as described herein below.

The water-soluble or water-dispersible copolymer I of the present invention comprises, in the form of polymerized units:

a) at least a monomer compound of general formula i:

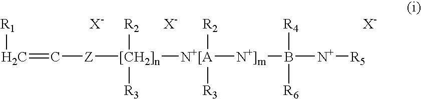

in which
R₁ is a hydrogen atom, a methyl or ethyl group;
R₂, R₃, R₄, R₅ and R₆, which are identical or different, are linear or branched about C₁-C₆, alkyl, hydroxyalkyl or aminoalkyl groups;
m is an integer from about 0 to about 10;
n is an integer from about 1 to about 6;
Z represents a —C(O)O— or —C(O)NH— group or an oxygen atom;
A represents a (CH₂)ₚ group, p being an integer from about 1 to about 6;
B represents a linear or branched C₂-C₁₂, polymethylene chain optionally interrupted by one or more heteroatoms or heterogroups, and optionally substituted by one or more hydroxyl or amino groups;
X⁻, which are identical or different, represent counterions; and
(b) at least one hydrophilic monomer carrying a functional acidic group which is copolymerizable with (a) and which is capable of being ionized in the application medium;
(c) optionally at least one monomer compound with ethylenic unsaturation with a neutral charge which is copolymerizable with (a) and (b), preferably a hydrophilic monomer compound with ethylenic unsaturation with a neutral charge, carrying one or more hydrophilic groups, which is copolymerizable with (a) and (b).

The monomer (a) can be prepared, for example, according to the reaction schemes shown in U.S. Pat. No. 6,569,261 to Rhodia, column 2, line 40 to column 3, line 45 which is incorporated herein by reference.

The resulting water-soluble or water-dispersible copolymer herein has a molecular mass of at least about 1000, advantageously of at least about 10,000; it can range up to about 20,000,000, advantageously up to about 10,000,000. Except when otherwise indicated, when the term molecular mass is used, it will refer to the weight-average molecular mass, expressed in g/mol. The latter can be determined by aqueous gel permeation chromatography (GPC) or measurement of the intrinsic viscosity in a 1N NaNO₃ solution at 30° C. The copolymer is preferably a random copolymer.

Preferably, in the general formula (i) of the monomer (a), Z represents C(O)O, C(O)NH or O, very preferably C(O)NH; n is equal to about 2 or about 3, very particularly about 3; m ranges from about 0 to about 2 and is preferably equal to about 0 or about 1, very particularly to about 0; B represents —CH2-CH(OH)—(CH2)q, with q from about 1 to about 4, preferably equal to about 1; R₁ to R₆, which are identical or different, represent a methyl or ethyl group.

A preferred monomer (a) is a diquat of following formula:

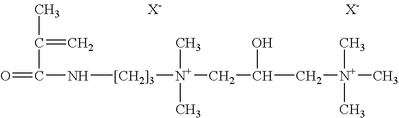

in which X⁻ representing the chloride ion.

Other particularly advantageous monomers (a) are:

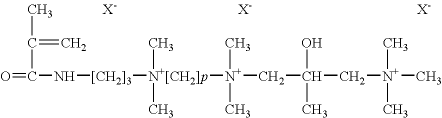

wherein p=2 to 4.

The X anions are in particular a halogen, preferably chlorine, sulfonate, sulfate, hydrogensulfate, phosphate, phosphonate, citrate, formate and acetate anion.

The monomers (b) are advantageously C₃-C₈ carboxylic, sulphonic, sulfuric, phosphonic or phosphoric acids with monoethylenic unsaturation, their anhydrides and their salts which are soluble in water and mixture thereof. Preferred monomers (b) are acrylic acid, methacrylic acid, α-ethacrylic acid, β,β-dimethylacrylic acid, methylenemalonic acid, vinylacetic acid, allylacetic acid, ethylidineacetic acid, propylidineacetic acid, crotonic acid, maleic acid, fumaric acid, itaconic acid, citraconic acid, mesaconic acid, N-(methacroyl)alanine, N-(acryloyl)hydroxyglycine, sulfopropyl acrylate, sulfoethyl acrylate, sulfoethyl methacrylate, styrenesulfonic acid, vinylsulfonic acid, vinylphosphonic acid, phosphoethyl acrylate, phophonoethyl acrylate, phosphopropyl acrylate, phophonopropyl acrylate, phosphoethyl methacrylate, phophonoethyl methacrylate, phosphopropyl methacrylate, phophonopropyl methacrylate and the alkali metal and ammonium salts thereof and mixtures thereof.

Preferred optional monomers (c) include acrylamide, vinyl alcohol, about C₁-C₄ alkyl esters of acrylic acid and of methacrylic acid, about C₁-C₄ hydroxyalkyl esters of acrylic acid and of methacrylic acid, in particular ethylene glycol and propylene glycol acrylate and methacrylate, polyalkoxylated esters of acrylic acid and of methacrylic acid, in particular the polyethylene glycol and polypropylene glycol esters, esters of acrylic acid or of methacrylic acid and of polyethylene glycol or polypropylene glycol about C₁-C₂₅ monoalkyl ethers, vinyl acetate, vinylpyrrolidone or methyl vinyl ether and mixtures thereof.

The level of monomers (a) is advantageously between about 3 and about 80 mol %, preferably about 10 to about 70 mol %. The level of monomers (b) is advantageously between about 10 and about 95 mol %, preferably about 20 to about 80 mol %. The level of monomers (c) is advantageously between about 0 and about 50%, preferably about 0 and about 30%. The molar ratio of cationic monomer to the anionic monomer (a)/(b) is advantageously between about 80/20 and about 5/95, preferably between about 60/40 and about 20/80.

The water-soluble or water-dispersible copolymer I herein can be obtained according to known techniques for the preparation of copolymers, in particular by polymerization by the radical route of the starting ethylenically unsaturated monomers, which are known compounds or compounds which can be easily obtained by a person skilled in the art by employing conventional synthetic processes of organic chemistry. Reference may in particular be made to the processes disclosed in U.S. Pat. No. 4,387,017 and EP 156,646. The radical polymerization is preferably carried out in an environment which is devoid of oxygen, for example in the presence of an inert gas (helium, argon, and the like) or of nitrogen. The reaction is carried out in an inert solvent, preferably ethanol or methanol, and more preferably in water. The polymerization is initiated by addition of a polymerization initiator. The initiators used are the free radical initiators commonly used in the art. Examples comprise organic peresters (t-butylperoxy pivalate, t-amylperoxy pivalate, t-butylperoxy α-ethylhexanoate, and the like); organic compounds of azo type, for example azobisamidinopropane hydrochloride, azobisisobutyronitrile, azobis(2,4-dimethylvaleronitrile), and the like); inorganic and organic peroxides, for example hydrogen peroxide, benzyl peroxide and butyl peroxide, and the like; redox initiating systems, for example those comprising oxidizing agents, such as persulfates (in particular ammonium or alkali metal persulfates, and the like); chlorates and bromates (including inorganic or organic chlorates and/or bromates); reducing agents, such as sulfites and bisulfites (including inorganic and/or organic sulfites or bisulfites); oxalic acid and ascorbic acid, as well as the mixtures of two or more of these compounds. Preferred initiators are water-soluble initiators. Sodium persulfate and azobisamidinopropane hydrochloride are in particular preferred. In an alternative form, the polymerization can be initiated by irradiation using ultraviolet light. The amount of initiators used is generally an amount sufficient can produce initiation of the polymerization. The initiators are preferably present in an amount ranging from about 0.001 to approximately about 10% by weight with respect to the total weight of the monomers and are preferably in an amount of less than about 0.5% by weight with respect to the total weight of the monomers, a preferred amount being situated in the range from about 0.005 to about 0.5% by weight with respect to the total weight of the monomers. The initiator is added to the polymerization mixture either continuously or noncontinuously. When it is wished to obtain copolymers of high molecular mass, it is desirable to add fresh initiator during the polymerization reaction. The gradual or noncontinuous addition also makes possible a more efficient polymerization and a shorter reaction time. The polymerization is carried out under reaction conditions which are effective in polymerizing the monomers (a), the monomers (b) and optionally the monomers (c) under an atmosphere devoid of oxygen. The reaction is preferably carried out at a temperature ranging from approximately 30° to approximately about 100° and preferably between about 60° and about 90° C. The atmosphere which is devoid of oxygen is maintained throughout the duration of the reaction, for example by maintaining a nitrogen flow throughout the reaction.

A particularly preferred water-soluble or water-dispersible copolymer I herein is the following:

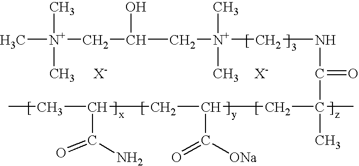

with x having a mean value of about 0 to about 50 mol %, preferably of about 0 to about 30 mol %, y having a mean value of about 10 to about 95 mol %, preferably of about 20 to about 80 mol %, z having a mean value of about 3 to about 80 mol %, preferably of about 10 to about 70 mol % and the y/z ratio preferably being of the order of about 4/1 to about 1/2, with x+y+z=100%, x, y and z representing the mol % of units derived from acrylamide, acrylic acid (sodium salt) and from Diquat respectively.

Other preferred water-soluble or water-dispersible copolymer I herein chemical structures are as follows:

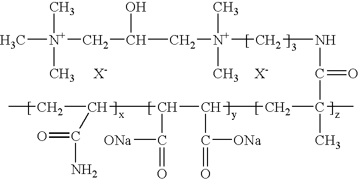

with x having a mean value of about 0 to about 50 mol %, preferably of about 0 to about 30 mol %, y having a mean value of about 10 to about 95 mol %, preferably of about 20 to about 80 mol %. z having a mean value of about 3 to about 80 mol %, preferably of about 10 to about 70 mol % and the y:z ratio preferably being of the order of about 4:1 to about 1:2;

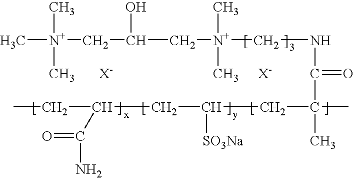

wherein x has a mean value of about 0 to about 50 mol %, preferably of about 0 to about 30 mol %, y has a mean value of about 10 to about 95 mol %, preferably of about 20 to about 80 mol %; z has a mean value of about 3 to about 80 mol %, preferably of about 10 to about 70 mol %, and the y:z ratio preferably being of the order of about 4:1 to about 1:2;

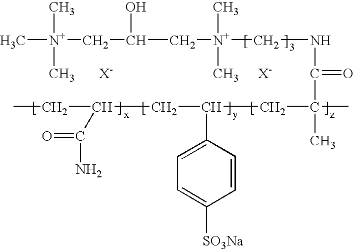

with x has a mean value of about 0 to about 50%, preferably of about 0 to about 30 mol %, y has a mean value of about 10 to about 95 mol %, preferably of about 20 to about 80 mol %, z has a mean value of about 3 to about 80 mol %, preferably of about 10 to about 70 mol %, and the y:z ratio preferably being of the order of about 4:1 to about 1:2;

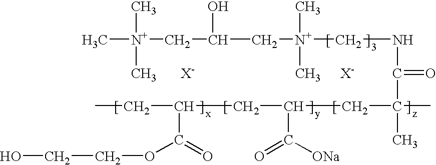

wherein x having a mean value of about 0 to about 50 mol %, preferably of about 0 to about 30 mol %, y has a mean value of about 10 to about 95 mol %, preferably of about 20 to about 80 mol %, z has a mean value of about 3 to about 80 mol %, preferably of about 10 to about 70 mol %, and the y:z ratio preferably being of the order of about 4:1 to about 1:2;

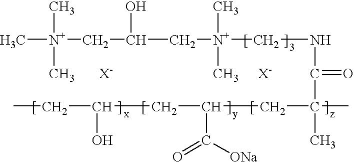

wherein x has a mean value of about 0 to about 50 mol %, preferably of about 0 to about 30 mol %, y has a mean value of about 10 to about 95 mol %, preferably of about 20 to about 80 mol %, z has a mean value of about 3 to about 80 mol %, preferably of about 10 to about 70 mol %, and the y:z ratio preferably being of the order of about 4:1 to about 1:2; or

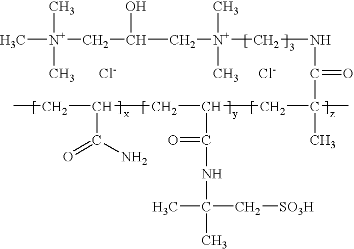

wherein x has a mean value of about 0 to about 50 mol %, preferably of about 0 to about 30 mol %, y has a mean value of about 10 to about 95 mol %, preferably of about 20 to about 80 mol %, z has a mean value of about 3 to about 80 mol %, preferably of about 10 to about 70 mol %, and the y:z ratio preferably being of the order of about 4:1 to about 1:2.

The water-soluble or water-dispersible copolymer II of the present invention comprises, in the form of polymerized units:

d) at least a monomer compound of general formula ii:

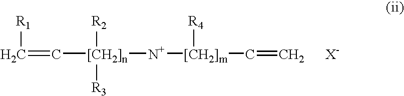

in which:
R1 and R4 independently represent H or about a C1-6 linear or branched alkyl group;
R2 and R3 independently represent a linear or branched about C1-6 alkyl, hydroxyalkyl or aminoalkyl group, preferably a methyl group;
n and m are integers of between about 1 and about 3;
X⁻ represents a counterion compatible with the water-soluble or water-dispersible nature of the polymer;
e) at least one hydrophilic monomer with an acid functionality that is copolymerisable with monomer d) and capable of ionizing in the medium in which it is used; and
f) optionally an ethylenically unsaturated hydrophilic monomer compound of neutral charge bearing one or several hydrophilic groups which is copolymerisable with monomers d) and e); the monomer d) to monomer e) ratio ranging from between about 60:40 and about 5:95.

More preferably, R₁ represents hydrogen, R₂ represents methyl, R₃ represents methyl, R₄ represents hydrogen, and m and n are equal to about 1. The ion X⁻ is preferably chosen from halogen, sulfate, hydrogen sulfate, phosphate, citrate, formate and acetate.

The monomer (e) and optionally the monomer (f) give the copolymer II hydrophilic properties. The copolymer II according to the invention advantageously has a molecular mass of at least about 1000, advantageously of at least about 10,000; it can be up to about 20,000,000, advantageously up to about 10,000,000. Except where otherwise indicated, when a molecular mass is mentioned, this will be the weight-average molecular mass, expressed in g/mol. This can be determined by aqueous gel permeation chromatography (GPC) or by measuring the intrinsic viscosity in a 1N NaNO₃ solution at 30° C. The copolymer II is preferably a random copolymer.

The monomer (d) preferably has the following structure:

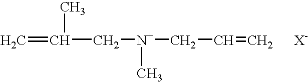

wherein X⁻ is defined above. One monomer (d) which is particularly preferred is that of the above formula in which X⁻ represents Cl⁻, this monomer being known as diallyl dimethyl ammonium chloride (DADMAC).

The monomers (e) are preferably those selected from the group consisting of water-soluble about C₃-C₈ carboxylic, sulfonic, sulfuric, phosphonic or phosphoric acids containing monoethylenic unsaturation, anhydrides thereof and water-soluble salts thereof. Among the preferred monomers (e) are those selected from the group consisting of acrylic acid, methacrylic acid, α-ethacrylic acid, β,β-dimethacrylic acid, methylenemalonic acid, vinylacetic acid, allylacetic acid, ethylideneacetic acid, propylideneacetic acid, crotonic acid, maleic acid, fumaric acid, itaconic acid, citraconic acid, mesaconic acid, N-meth-acryloylalanine, N-acryloylhydroxyglycine, sulfopropyl acrylate, sulfoethyl acrylate, sulfoethyl methacrylate, sulfoethyl methacrylate, styrenesulfonic acid, vinylsulfonic acid, vinylphosphonic acid, phosphoethyl acrylate, phosphonoethyl acrylate, phosphopropyl acrylate, phosphonopropyl acrylate, phosphoethyl methacrylate, phosphonoethyl methacrylate, phosphopropyl methacrylate and phosphonopropyl methacrylate, and the ammonium and alkali metal salts of these acids and mixtures thereof.

Among the monomers (f) are those selected from the group consisting of acrylamide, vinyl alcohol, about C₁-C₄ alkyl esters of acrylic acid and of methacrylic acid, about C₁-C₄ hydroxyalkyl esters of acrylic acid and of methacrylic acid, in particular ethylene glycol and propylene glycol acrylate and methacrylate, polyalkoxylated esters of acrylic acid and of methacrylic acid, in particular the polyethylene glycol and polypropylene glycol esters.

The monomer (d) content is advantageously between about 5 mol % and about 60 mol %, preferably about 20 mol % to about 50 mol %. The monomer (e) content is advantageously between about 10 mol % and about 95 mol %, preferably about 20 mol % to about 80 mol %. The monomer (f) content is advantageously between about 0 mol % and about 50 mol %, preferably about 5 mol % to about 30 mol %. The d:e molar ratio is preferably between about 50:50 and about 10:90.

The copolymers II of the invention can be obtained according to the known techniques for preparing copolymers, in particular by radical-mediated polymerization of the ethylenically unsaturated starting monomers which are known compounds or which can readily be obtained by a person skilled in the art using conventional synthetic processes of organic chemistry. Water-soluble or water-dispersible copolymer II is preferably obtained by the copolymerization of monomers containing a quaternary ammonium function and two groups containing ethylenic unsaturation with monomers containing a group capable of ionizing in the application medium to form anionic units, with a ratio of the first monomers to the second monomers which is within a given range. The radical-mediated polymerization is described in detail earlier with respect to agglomerating copolymer I.

The following copolymers II are most particularly preferred: DADMAC/acrylic acid/acrylamide copolymer; DADMAC/maleic acid copolymer; DADMAC/sulfonic acid copolymer; the DADMAC/acidic monomer molar ratio being between about 60:40 and about 5:95, preferably between about 50:50 and about 10:90. DADMAC stands for diallyl dimethyl ammonium chloride. Preferred copolymer II are available from Rhodia; an alternative is available from Reckitt-Benckiser under the tradename Merquat 280. A particularly preferred copolymer II is

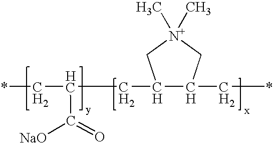

Preferred water-soluble or water-dispersible copolymer herein are available from Rhodia. In the composition of the present invention, the water-soluble or water-dispersible copolymer herein is preferably present at a level of from about 0.001% to about 10%, more preferably from about 0.005% to about 1%, most preferably from about 0.01% to about 0.5% by weight of the composition.

It has been found that the presence of the specific water-soluble or water-dispersible copolymer herein in a liquid composition used to clean a hard surface in a dilute/no rinse application allows to provide improved filming and/or streaking performance as well as improved shine performance as compared to the use in the same dilute/no rinse hard surface cleaning application of a composition that are free of the specific water-soluble or water-dispersible copolymer herein. Furthermore, it has been found that the presence of the specific water-soluble or water-dispersible copolymer herein in a liquid composition used to clean a hard surface in a dilute/no rinse application allows to provide improved soil repellency properties to the hard surface after an initial cleaning operation with the compositions herein using a process according to the present invention. Moreover, it has been found that the presence of the specific water-soluble or water-dispersible copolymer herein in a liquid composition used to clean a hard surface in a dilute/no rinse application allows to provide improved next time cleaning benefit properties to the hard surface after an initial cleaning operation with the compositions herein using a process according to the present invention.

Due to its nature, after a dilute/no rinse hard surface cleaning application residues are left on the hard surface cleaned in such an-application. Indeed, due to the fact that the cleaning composition applied onto the surface is not rinsed off the surface, the cleaning composition along with a part of the soil present on the hard surface is basically left on the surface (another part of the soil is captured in the implement (e.g., mop), if any, used in the dilute/no rinse cleaning application). Such residues often lead to visible films and/or streaks on the cleaned hard surface and may impair the shine of the hard surface. Moreover, cleaned surfaces are prone to re-soiling due to their normal use. Indeed, marks, soils, stains and the like of various kinds are deposited on hard surface upon use (e.g., soil carried onto a floor sticking the bottom of shoes).

It has surprisingly been found that the inclusion of said copolymer in a liquid composition used in a dilute/no rinse hard surface cleaning application provides a composition that increases the transparency of the residues (after drying) left on the hard surface after cleaning. Such an increase in transparency results in the residues being less or even not at all visible, which in turns significantly contributes to the fact that films and/or streaks are barely or even not at all visible on the cleaned hard surface and also to an improved shine of the cleaned hard surface. Furthermore, it has surprisingly been found that on a hard surface initially cleaned with the compositions herein using a process according to the present invention, soils deposition is reduced or even prevented. Indeed, so-called soil repellency properties are observed. In addition, it has surprisingly been found that on a hard surface initially cleaned with the compositions herein using a process according to the present invention, a next time cleaning benefit is observed. Indeed, subsequent cleaning operations of an initially cleaned surface are facilitated.

In an alternative embodiment, the present invention also encompasses the use of a water-soluble or water-dispersible copolymer herein in a process of cleaning a hard surface with a liquid composition comprising the water-soluble or water-dispersible copolymer herein wherein the process comprises the step of applying said composition in its neat form onto said hard surface, wherein good filming and/or streaking performance as well as good shine performance.

By “in its neat form”, it is meant herein that said liquid composition is applied directly onto the surface to be treated without undergoing any dilution by the user (immediately) prior to the application, i.e., the liquid composition herein is applied onto the hard surface as described herein.

It has been found that the presence of the specific water-soluble or water-dispersible copolymer herein in a liquid composition used to clean a hard surface in neat application allows to provide improved filming and/or streaking performance as well as improved shine performance as compared to the use in the same neat hard surface cleaning application of a composition that are free of the specific water-soluble or water-dispersible copolymer herein.

Due to its nature, after a neat hard surface cleaning application residues may be left on the hard surface cleaned in such an application. Indeed, after a neat cleaning application the cleaned hard surface may or may not be rinsed. Even if the hard surface is rinsed after the neat cleaning application, residues of the cleaning composition (though diluted) may still remain on the hard surface due to inefficient rinsing and due to the increased concentration that was initially applied onto the hard surface. Hence, the cleaning composition along with part of the soil present on the hard surface may be left on the surface. Such residues often lead to visible films and/or streaks on the cleaned hard surface and may impair he shine of the hard surface.

It has been surprisingly found that the inclusion of said copolymer in a liquid composition used in a neat hard surface cleaning application provides a composition that increases the transparency of the residues (after drying) left on the hard surface after cleaning. As outlined above, such an increase in transparency results in the residues being less or even not at all visible, which in turns significantly contributes to fact that films and/or streaks are barely or even not at all visible on the cleaned hard surface and also to an improved shine of the cleaned hard surface.

### Filming/Streaking and Shine Test Method

The filming/streaking and shine performance of a diluted hard surface cleaning composition is evaluated using the following test methods:

The hard surface cleaning composition is diluted to a 1.2% level (detergent solution) in normal tap-water, if needed adjusted with CaCl₂ to achieve a particular water hardness of interest, mostly 16 gpg. 19 g (+/−0.2 g) of said detergent solution is applied on a Vileda® cloth (20 cm*9 cm), followed by wiping lightly covering a surface of four black glossy ceramic tiles (20*25 cm each), wherein approx. 1 g. (+/−0.2 g) of detergent solution is left on the tile. Afterwards the tile is left to dry without rinsing at constant temperature (22° C.) and constant humidity (30-40% rH).

The shine performance is evaluated by visual assessment of a tile being cleaned with a wash solution containing polymer, versus a tile being cleaned with the same wash solution though not containing the polymer.

The filming/streaking and/or shine performance of said composition can be assessed by visual grading. The visual grading may be performed by a group of expert panellists using panel score units (PSU). To assess the filming/streaking and/or shine performance of a given composition a PSU-scale ranging from 0, meaning a poor filming/streaking and/or shine impression (i.e., visible filing/streaking; no shine) of the given composition, to 6, meaning a good filming/streaking and/or shine impression (i.e., no visible filing/streaking; excellent shine) of the given composition, can be applied.

The filming/streaking and shine performance of an undiluted hard surface cleaning composition is evaluated using the following test methods:

1 ml of hard surface cleaning composition is applied neat onto two black glossy ceramic tiles (20*25 cm each), followed by wiping lightly with a wet Vileda® cloth (20 cm*9 cm—containing 10 g of water). Afterwards the Vileda® cloth is squeezed 10 times under running tap water. The tiles are rinsed twice with this squeezed/rinsed Vileda® cloth (containing 10 g of water), and left to dry at constant temperature (22° C.) and constant humidity (30-40% rH).

The filming/streaking and/or shine performance of said composition can be assessed by visual grading as described herein above.

### Soil Repellency and Next Time Cleaning Benefit Test Method

The next time cleaning/soil repellency performance of a diluted hard surface cleaning composition is evaluated using the following test methods:

A clean white ceramic tile (ex Villeroy & Bosch® UT01 Series Unit 1—dimensions 7*25 cm) is pretreated with test and reference products to be assessed by using a “Wet Abrasion Scrub Tester—Ref. 903PG/SA/B, available from Sheen Instruments Limited), a straight-line washability machine having 4 cleaning tracks and 4 sponge holders. Two cleaning tracks are preconditioned with a wet sponge (yellow cellulose sponge, Type 7 ex Spontex US—total weight wet sponge=22 g+/−2 g) to which 20 ml (+/−0.2 ml) of a 1.2% detergent solution (see above for preparation) is added, the two other cleaning tracks are preconditioned with a wet sponge containing 20 ml (+/−0.2 ml) of a 1.2% wash solution of a reference detergent solution. The tile is pretreated over 20 cycles, followed by allowing the tile to dry at constant temperature (25° C.) and humidity (70% rH) for at least 2 hours, preferably overnight.

A soil mix of polymerized oil and particulate soil is prepared and 0.085 g of the soil mix is homogeneously distributed over the pretreated tile. After application, the soiled tile is left to condition for 3-5 hours, preferably overnight, at constant temperature (25° C.) and humidity (70% rH).

To cross-evaluate the cleaning performance of the test versus reference detergent solution, the number of counts is recorded to fully clean the pretreated tile areas by a sponge containing 20 ml (+/−0.2 ml) of the corresponding 1.2% detergent solution, using the “Wet Abrasion Scrub Tester” as mentioned above.

### Optional Composition Ingredients

The liquid compositions according to the present invention may comprise a variety of optional ingredients depending on the technical benefit aimed for and the surface treated.

Suitable optional ingredients for use herein include surfactants, builders, chelants, polymers, buffers, bactericides, preservatives, hydrotropes, colorants, stabilisers, radical scavengers, bleaches, bleach activators, enzymes, soil suspenders, dye transfer agents, brighteners, anti dusting agents, dispersants, dye transfer inhibitors, pigments, silicones, perfumes and/or dyes.

### Surfactants

The compositions herein may comprise a nonionic, anionic, zwitterionic and amphoteric surfactant or mixtures thereof. Said surfactant is preferably present at a level of from about 0.01% to about 20% of composition herein. Suitable surfactants are those selected from the group consisting of nonionic, anionic, zwitterionic and amphoteric surfactants, having hydrophobic chains containing from about 8 to about 18 carbon atoms. Examples of suitable surfactants are described in McCutcheon's Vol. 1: Emulsifiers and Detergents, North American Ed., McCutcheon Division, MC Publishing Co., 2002.

Preferably, the aqueous compositions comprise from about 0.01% to about 20%, more preferably from about 0.5% to about 10%, and most preferably from about 1% to about 5% surfactants.

Non-ionic surfactants are highly preferred for use in the compositions of the present invention. Non-limiting examples of suitable non-ionic surfactants include alcohol alkoxylates, alkyl polysaccharides, amine oxides, block copolymers of ethylene oxide and propylene oxide, fluoro surfactants and silicon based surfactants. Preferably, the aqueous compositions comprise from about 0.01% to about 20%, more preferably from about 0.5% to about 10%, and most preferably from about 1% to about 5% non-ionic surfactants.

A preferred class of non-ionic surfactants suitable for the present invention is alkyl ethoxylates. The alkyl ethoxylates of the present invention are either linear or branched, and contain from about 8 carbon atoms to about 16 carbon atoms in the hydrophobic tail, and from about 3 ethylene oxide units to about 25 ethylene oxide units in the hydrophilic head group. Examples of alkyl ethoxylates include Neodol 91-6®, Neodol 91-8® supplied by the Shell Corporation (P.O. Box 2463, 1 Shell Plaza, Houston, Tex.), and Alfonic 810-60® supplied by Condea Corporation, (900 Threadneedle P.O. Box 19029, Houston, Tex.). More preferred alkyl ethoxylates comprise from about 9 to about 12 carbon atoms in the hydrophobic tail, and from about 4 to about 9 oxide units in the hydrophilic head group. A most preferred alkyl ethoxylate is C₉₋₁₁ EO₅, available from the Shell Chemical Company under the tradename Neodol 91-5®. Non-ionic ethoxylates can also be derived from branched alcohols. For example, alcohols can be made from branched olefin feedstocks such as propylene or butylene. In a preferred embodiment, the branched alcohol is either a 2-propyl-1-heptyl alcohol or 2-butyl-1-octyl alcohol. A desirable branched alcohol ethoxylate is 2-propyl-1-heptyl EO7/AO7, manufactured and sold by BASF Corporation under the tradename Lutensol XP 79/XL 79®.

Another class of non-ionic surfactant suitable for the present invention is alkyl polysaccharides. Such surfactants are disclosed in U.S. Pat. Nos. 4,565,647, 5,776,872, 5,883,062, and 5,906,973. Among alkyl polysaccharides, alkyl polyglycosides comprising five and/or six carbon sugar rings are preferred, those comprising six carbon sugar rings are more preferred, and those wherein the six carbon sugar ring is derived from glucose, i.e., alkyl polyglucosides (“APG”), are most preferred. The alkyl substituent in the APG chain length is preferably a saturated or unsaturated alkyl moiety containing from 8 to 16 carbon atoms, with an average chain length of 10 carbon atoms. C₈-C₁₆ alkyl polyglucosides are commercially available from several suppliers (e.g., Simusol® surfactants from Seppic Corporation, 75 Quaid'Orsay, 75321 Paris, Cedex 7, France, and Glucopon 220®, Glucopon 225®, Glucopon 425®, Plantaren 2000 N®, and Plantaren 2000 N UP®, from Cognis Corporation, Postfach 13 01 64, D 40551, Dusseldorf, Germany).

Another class of non-ionic surfactant suitable for the present invention is amine oxide. Amine oxides, particularly those comprising from about 10 carbon atoms to about 16 carbon atoms in the hydrophobic tail, are beneficial because of their strong cleaning profile and effectiveness even at levels below about 0.10%. Additionally about C₁₀₋₁₆ amine oxides, especially about C₁₂-C₁₄ amine oxides are excellent solubilizers of perfume. Alternative non-ionic detergent surfactants for use herein are alkoxylated alcohols generally comprising from about 8 to about 16 carbon atoms in the hydrophobic alkyl chain of the alcohol. Typical alkoxylation groups are propoxy groups or ethoxy groups in combination with propoxy groups, yielding alkyl ethoxy propoxylates. Such compounds are commercially available under the tradename Antarox® available from Rhodia (40 Rue de la Haie-Coq F-93306, Aubervilliers Cédex, France) and under the tradename Nonidet® available from Shell Chemical.

Also suitable for use in the present invention are the fluorinated nonionic surfactants. One particularly suitable fluorinated nonionic surfactant is Fluorad F170 (3M Corporation, 3M Center, St. Paul, Minn., USA). Fluorad F170 has the formula C₈F₁₇SO₂N(CH₂—CH₃)(CH₂CH₂O)ₓ. Also suitable for use in the present invention are silicon-based surfactants. One example of these types of surfactants is Silwet L7604 available from Dow Chemical (1691 N. Swede Road, Midland, Mich., USA).

The condensation products of ethylene oxide with a hydrophobic base formed by the condensation of propylene oxide with propylene glycol are also suitable for use herein. The hydrophobic portion of these compounds will preferably have a molecular weight of from about 1500 to about 1800 and will exhibit water insolubility. The addition of polyoxyethylene moieties to this hydrophobic portion tends to increase the water solubility of the molecule as a whole, and the liquid character of the product is retained up to the point where the polyoxyethylene content is about 50% of the total weight of the condensation product, which corresponds to condensation with up to about 40 moles of ethylene oxide. Examples of compounds of this type include certain of the commercially available Pluronic® surfactants, marketed by BASF. Chemically, such surfactants have the structure (EO)ₓ(PO)_{y}(EO)_{z} or (PO)ₓ(EO)_{y}(PO)_{z} wherein x, y, and z are from about 1 to about 100, preferably about 3 to about 50. Pluronic® surfactants known to be good wetting surfactants are more preferred. A description of the Pluronic® surfactants, and properties thereof, including wetting properties, can be found in the brochure entitled “BASF Performance Chemicals Plutonic® & Tetronic® Surfactants”, available from BASF.

Other suitable though not preferred non-ionic surfactants include the polyethylene oxide condensates of alkyl phenols, e.g., the condensation products of alkyl phenols having an alkyl group containing from about 6 to about 12 carbon atoms in either a straight chain or branched chain configuration, with ethylene oxide, the said ethylene oxide being present in amounts equal to about 5 to about 25 moles of ethylene oxide per mole of alkyl phenol. The alkyl substituent in such compounds can be derived from oligomerized propylene, diisobutylene, or from other sources of iso-octane n-octane, iso-nonane or n-nonane. Other non-ionic surfactants that can be used include those derived from natural sources such as sugars and include C₈-C₁₆ N-alkyl glucose amide surfactants.

Suitable anionic surfactants for use herein are all those commonly known by those skilled in the art. Preferably, the anionic surfactants for use herein include alkyl sulphonates, alkyl aryl sulphonates, alkyl sulphates, alkyl alkoxylated sulphates, about C₆-C₂₀ alkyl alkoxylated linear or branched diphenyl oxide disulphonates, or mixtures thereof.

Suitable alkyl sulphonates for use herein include water-soluble salts or acids of the formula RSO₃M wherein R is a about C₆-C₂₀ linear or branched, saturated or unsaturated alkyl group, preferably a about C₈-C₁₈ alkyl group and more preferably a about C₁₀-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Suitable alkyl aryl sulphonates for use herein include water-soluble salts or acids of the formula RSO₃M wherein R is an aryl, preferably a benzyl, substituted by a about C₆-C₂₀ linear or branched saturated or unsaturated alkyl group, preferably a about C₈-C₁₈ alkyl group and more preferably a about C₁₀-C₁₆ alkyl group, and M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

An example of a C₁₄-C₁₆ alkyl sulphonate is Hostapur® SAS available from Hoechst. An example of commercially available alkyl aryl sulphonate is Lauryl aryl sulphonate from Su.Ma. Particularly preferred alkyl aryl sulphonates are alkyl benzene sulphonates commercially available under trade name Nansa® available from Albright&Wilson.

Suitable alkyl sulphate surfactants for use herein are according to the formula R₁ SO₄M wherein R₁ represents a hydrocarbon group selected from the group consisting of straight or branched alkyl radicals containing from about 6 to about 20 carbon atoms and alkyl phenyl radicals containing from about 6 to about 18 carbon atoms in the alkyl group. M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Particularly preferred branched alkyl sulphates to be used herein are those containing from 10 to 14 total carbon atoms like Isalchem 123 AS®. Isalchem 123 AS® commercially available from Enichem is a C₁₂₋₁₃ surfactant which is 94% branched. This material can be described as CH₃—(CH₂)ₘ—CH(CH₂OSO₃Na)—(CH₂)ₙ—CH₃ where n+m=8-9. Also preferred alkyl sulphates are the alkyl sulphates where the alkyl chain comprises a total of 12 carbon atoms, i.e., sodium 2-butyl octyl sulphate. Such alkyl sulphate is commercially available from Condea under the trade name Isofol® 12S. Particularly suitable liner alkyl sulphonates include about C₁₂-C₁₆ paraffin sulphonate like Hostapur® SAS commercially available from Hoechst.

Suitable alkyl alkoxylated sulphate surfactants for use herein are according to the formula RO(A)ₘSO₃M wherein R is an unsubstituted about C₆-C₂₀ alkyl or hydroxyalkyl group having about a C₆-C₂₀ alkyl component, preferably about a C₁₂-C₂₀ alkyl or hydroxyalkyl, more preferably about C₁₂-C₁₈ alkyl or hydroxyalkyl, A is an ethoxy or propoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein. Specific examples of substituted ammonium cations include methyl-, dimethyl-, trimethyl-ammonium and quaternary ammonium cations, such as tetramethyl-ammonium, dimethyl piperdinium and cations derived from alkanolamines such as ethylamine, diethylamine, triethylamine, mixtures thereof, and the like. Exemplary surfactants are C₁₂-C₁₈ alkyl polyethoxylate (1.0) sulfate (C₁₂-C₁₈E(1.0)SM), C₁₂-C₁₈ alkyl polyethoxylate (2.25) sulfate (C₁₂-C₁₈E(2.25)SM), C₁₂-C₁₈ alkyl polyethoxylate (3.0) sulfate (C₁₂-C₁₈E(3.0)SM), and C₁₂-C₁₈ alkyl polyethoxylate (4.0) sulfate (C₁₂-C₁₈E(4.0)SM), wherein M is conveniently selected from sodium and potassium.

Suitable C₆-C₂₀ alkyl alkoxylated linear or branched diphenyl oxide disulphonate surfactants for use herein are according to the following formula:

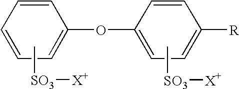

wherein R is a C₆-C₂₀ linear or branched, saturated or unsaturated alkyl group, preferably a C₁₂-C₁₈ alkyl group and more preferably a C₁₄-C₁₆ alkyl group, and X+ is H or a cation, e.g., an alkali metal cation (e.g., sodium, potassium, lithium, calcium, magnesium and the like). Particularly suitable about C₆-C₂₀ alkyl alkoxylated linear or branched diphenyl oxide disulphonate surfactants to be used herein are the C12 branched di phenyl oxide disulphonic acid and about C16 linear di phenyl oxide disulphonate sodium salt respectively commercially available by DOW under the trade name Dowfax 2A1® and Dowfax 8390®.

Other anionic surfactants useful herein include salts (including, for example, sodium, potassium, ammonium, and substituted ammonium salts such as mono-, di- and triethanolamine salts) of soap, about C₈-C₂₄ olefinsulfonates, sulphonated polycarboxylic acids prepared by sulphonation of the pyrolyzed product of alkaline earth metal citrates, e.g., as described in British patent specification No. 1,082,179, C₈-C₂₄ alkylpolyglycolethersulfates (containing up to 10 moles of ethylene oxide); alkyl ester sulfonates such as about C₁₄₋₁₆ methyl ester sulfonates; acyl glycerol sulfonates, fatty oleyl glycerol sulfates, alkyl phenol ethylene oxide ether sulfates, alkyl phosphates, isethionates such as the acyl isethionates, N-acyl taurates, alkyl succinamates and sulfosuccinates, monoesters of sulfosuccinate (especially saturated and unsaturated about C₁₂-C₁₈ monoesters) diesters of sulfosuccinate (especially saturated and unsaturated about C₆-C₁₄ diesters), acyl sarcosinates, sulfates of alkylpolysaccharides such as the sulfates of alkylpolyglucoside (the nonionic nonsulfated compounds being described below), alkyl polyethoxy carboxylates such as those of the formula RO(CH₂CH₂O)ₖCH₂COO-M⁺ wherein R is about a C₈-C₂₂ alkyl, k is an integer from about 0 to about 10, and M is a soluble salt-forming cation. Resin acids and hydrogenated resin acids are also suitable, such as rosin, hydrogenated rosin, and resin acids and hydrogenated resin acids present in or derived from tall oil. Further examples are given in “Surface Active Agents and Detergents” (Vol. I and II by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23.

Zwitterionic surfactants represent another class of preferred surfactants within the context of the present invention.

Zwitterionic surfactants contain both cationic and anionic groups on the same molecule over a wide pH range. The typical cationic group is a quaternary ammonium group, although other positively charged groups like sulfonium and phosphonium groups can also be used. The typical anionic groups are carboxylates and sulfonates, preferably sulfonates, although other groups like sulfates, phosphates and the like, can be used. Some common examples of these detergents are described in the patent literature: U.S. Pat. Nos. 2,082,275, 2,702,279 and 2,255,082.

A specific example of a zwitterionic surfactant is 3-(N-dodecyl-N,N-dimethyl)-2-hydroxypropane-1-sulfonate (Lauryl hydroxyl sultaine) available from the McIntyre Company (24601 Governors Highway, University Park, Ill. 60466, USA) under the tradename Mackam LHS®. Another specific zwitterionic surfactant is C₁₂₋₁₄ acylamidopropylene (hydroxypropylene) sulfobetaine that is available from McIntyre under the tradename Mackam 50-SB®. Other very useful zwitterionic surfactants include hydrocarbyl, e.g., fatty alkylene betaines. A highly preferred zwitterionic surfactant is Empigen BB®, a coco dimethyl betaine produced by Albright & Wilson. Another equally preferred zwitterionic surfactant is Mackam 35HP®, a coco amido propyl betaine produced by McIntyre.

Another class of preferred surfactants comprises the group consisting of amphoteric surfactants. One suitable amphoteric surfactant is about a C₈-C₁₆ amido alkylene glycinate surfactant (‘ampho glycinate’). Another suitable amphoteric surfactant is about a C₈-C₁₆ amido alkylene propionate surfactant (‘ampho propionate’). Other suitable, amphoteric surfactants are represented by surfactants such as dodecylbeta-alanine, N-alkyltaurines such as the one prepared by reacting dodecylamine with sodium isethionate according to the teaching of U.S. Pat. No. 2,658,072, N-higher alkylaspartic acids such as those produced according to the teaching of U.S. Pat. No. 2,438,091, and the products sold under the trade name “Miranol®”, and described in U.S. Pat. No. 2,528,378.

The weight ratio of water-soluble or water-dispersible copolymer herein to nonionic, anionic, amphoteric, zwitterionic surfactant or mixtures thereof is between 1:100 and 10:1, more preferably between 1:50 and 1:1.

### Chelating Agents

One class of optional compounds for use herein includes chelating agents or mixtures thereof. Chelating agents can be incorporated in the compositions herein in amounts ranging from about 0.0% to about 10.0% by weight of the total composition, preferably about 0.01% to about 5.0%.

Suitable phosphonate chelating agents for use herein may include alkali metal ethane 1-hydroxy diphosphonates (HEDP), alkylene poly(alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins. Ethylenediamine N,N′-disuccinic acids is, for instance, commercially available under the tradename ssEDDS® from Palmer Research Laboratories.

Suitable amino carboxylates for use herein include ethylene diamine tetra acetates, diethylene triamine pentaacetates, diethylene triamine pentaacetate (DTPA),N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA).

Further carboxylate chelating agents for use herein include salicylic acid, aspartic acid, glutamic acid, glycine, malonic acid or mixtures thereof.

### Fatty Acid

The liquid compositions of the present invention may comprise a fatty acid, or mixtures thereof as an optional ingredient.

Suitable fatty acids for use herein are the alkali salts of about a C₈-C₂₄ fatty acid. Such alkali salts include the metal fully saturated salts like sodium, potassium and/or lithium salts as well as the ammonium and/or alkylammonium salts of fatty acids, preferably the sodium salt. Preferred fatty acids for use herein contain from about 8 to about 22, preferably from about 8 to about 20 and more preferably from about 8 to about 18 carbon atoms.

Suitable fatty acids may be selected from caprylic acid, capric acid, lauric acid, myristic acid, palmitic acid, stearic acid, oleic acid, and mixtures of fatty acids suitably hardened, derived from natural sources such as plant or animal esters (e.g., palm oil, olive oil, coconut oil, soybean oil, castor oil, tallow, ground oil, whale and fish oils and/or babassu oil.

For example Coconut Fatty Acid is commercially available from UNICHEMA under the name PRIFAC 5900®.

Fatty acids are desired herein as they reduce the sudsing of the liquid composition used in the process according to the present invention.

Typically, the liquid composition herein may comprise up to about 6%, preferably from about 0.1% to about 2.0%, more preferably from about 0.1% to about 1.0% and most preferably from about 0.2% to about 0.8% by weight of the total composition of said fatty acid.

### Branched Fatty Alcohol

The liquid compositions of the present invention may comprise a branched fatty alcohol, or mixtures thereof as a highly preferred optional ingredient.

Such suitable compounds are commercially available, for instance, as the Isofol® series such as Isofol® 12 (2-butyl octanol) or Isofol® 16 (2-hexyl decanol) commercially available from Condea.

Preferably said branched fatty alcohol is selected from the group consisting of 2-butyl octanol, 2-hexyl decanol, and a mixture thereof. More preferably said 2-alkyl alkanol is 2-butyl octanol.

Typically, the liquid composition herein may comprise up to about 2%, preferably from about 0.10% to about 1.0%, more preferably from about 0.1% to about 0.8% and most preferably from about 0.1% to about 0.5% by weight of the total composition of said branched fatty alcohol.

### Solvent

The liquid compositions of the present invention may comprise a solvent, or mixtures thereof as an optional ingredient.

Suitable solvent is selected from the group consisting of: ethers and diethers having from about 4 to about 14 carbon atoms, preferably from about 6 to about 12 carbon atoms, and more preferably from about 8 to about 10 carbon atoms; glycols or alkoxylated glycols; alkoxylated aromatic alcohols; aromatic alcohols; alkoxylated aliphatic alcohols; aliphatic alcohols; about C₈-C₁₄ alkyl and cycloalkyl hydrocarbons and halohydrocarbons; about C₆-C₁₆ glycol ethers; terpenes; and mixtures thereof.

Suitable glycols to be used herein are according to the formula HO—CR₁R₂—OH wherein R₁ and R₂ are independently H or a C₂-C₁₀ saturated or unsaturated aliphatic hydrocarbon chain and/or cyclic. Suitable glycols to be used herein are dodecaneglycol and/or propanediol.

Suitable alkoxylated glycols to be used herein are according to the formula R-(A)ₙ-R₁—OH wherein R is H, OH, a linear or branched, saturated or unsaturated alkyl of from about 1 to about 20 carbon atoms, preferably from about 2 to about 15 and more preferably from about 2 to about 10, wherein R₁ is H or a linear saturated or unsaturated alkyl of from about 1 to about 20 carbon atoms, preferably from about 2 to about 15 and more preferably from about 2 to about 10, and A is an alkoxy group preferably ethoxy, methoxy, and/or propoxy and n is from about 1 to about 5, preferably about 1 to about 2. Suitable alkoxylated glycols to be used herein are methoxy octadecanol and/or ethoxyethoxyethanol.

Suitable alkoxylated aromatic alcohols to be used herein are according to the formula R-(A)ₙ-OH wherein R is an alkyl substituted or non-alkyl substituted aryl group of from about 1 to about 20 carbon atoms, preferably from about 2 to about 15 and more preferably from about 2 to about 10, wherein A is an alkoxy group preferably butoxy, propoxy and/or ethoxy, and n is an integer of from about 1 to about 5, preferably about 1 to about 2. Suitable alkoxylated aromatic alcohols are benzoxyethanol and/or benzoxypropanol.

Suitable aromatic alcohols to be used herein are according to the formula R—OH wherein R is an alkyl substituted or non-alkyl substituted aryl group of from about 1 to about 20 carbon atoms, preferably from about 1 to about 15 and more preferably from about 1 to about 10. For example a suitable aromatic alcohol to be used herein is benzyl alcohol.

Suitable alkoxylated aliphatic alcohols to be used herein are according to the formula R-(A)ₙ-OH wherein R is a linear or branched, saturated or unsaturated alkyl group of from about 1 to about 20 carbon atoms, preferably from about 2 to about 15 and more preferably from about 3 to about 12, wherein A is an alkoxy group preferably butoxy, propoxy and/or ethoxy, and n is an integer of from about 1 to about 5, preferably about 1 to about 2. Suitable alkoxylated aliphatic linear or branched alcohols are butoxy propoxy propanol (n-BPP), butoxyethanol, butoxypropanol (n-BP), ethoxyethanol, 1-methylpropoxyethanol, 2-methylbutoxyethanol, or mixtures thereof. Butoxy propoxy propanol is commercially available under the trade name n-BPP® from Dow Chemical. Butoxypropanol is commercially available from Dow Chemical.

Suitable aliphatic alcohols to be used herein are according to the formula R—OH wherein R is a linear or branched, saturated or unsaturated alkyl group of from about 1 to about 20 carbon atoms, preferably from about 2 to about 15 and more preferably from about 5 to about 12. With the proviso that said aliphatic branched alcohols is not a 2-alkyl alkanol as described herein above. Suitable aliphatic alcohols are methanol, ethanol, propanol, isopropanol or mixtures thereof.

Suitable terpenes to be used herein monocyclic terpenes, dicyclic terpenes and/or acyclic terpenes. Suitable terpenes are: D-limonene; pinene; pine oil; terpinene; terpene derivatives as menthol, terpineol, geraniol, thymol; and the citronella or citronellol types of ingredients.

Other suitable solvents include butyl diglycol ether (BDGE), hexandiols, butyltriglycol ether, ter amilic alcohol and the like. BDGE is commercially available from Union Carbide or from BASF under the trade name Butyl CARBITOL®.

Preferably said solvent is selected from the group consisting of butoxy propoxy propanol, butyl diglycol ether, benzyl alcohol, butoxypropanol, ethanol, methanol, isopropanol, hexandiols and mixtures thereof. More preferably said solvent is selected from the group consisting of butoxy propoxy propanol, butyl diglycol ether, benzyl alcohol, butoxypropanol, ethanol, methanol, isopropanol and mixtures thereof. Even more preferably said solvent is selected from the group consisting of butyl diglycol ether, butoxypropanol, ethanol and mixtures thereof.

Typically, the liquid composition herein may comprise up to about 30%, preferably from about 1% to about 25%, more preferably from about 1% to about 20% and most preferably from about 2% to about 10% by weight of the total composition of said solvent or mixture thereof.

In a preferred embodiment the solvent comprised in the liquid composition according to the present invention is a volatile solvent or a mixture thereof, preferably a volatile solvent or a mixture thereof in combination with another solvent or a mixture thereof.

### Perfumes

The liquid compositions of the present invention may comprise a perfume or a mixture thereof as a highly preferred optional ingredient.

Suitable perfumes for use herein include materials which provide an olfactory aesthetic benefit and/or cover any “chemical” odor that the product may have.

The compositions herein may comprise a perfume or a mixture thereof, in amounts up to about 5.0%, preferably in amounts of about 0.01% to about 2.0%, more preferably in amounts of about 0.05% to about 1.5%, even more preferably in amounts of about 0.1% to about 1.0%, by weight of the total composition.

### Builders

The liquid compositions of the present invention may also comprise a builder or a mixture thereof, as an optional ingredient.

Suitable builders for use herein include polycarboxylates and polyphosphates, and salts thereof. Typically, the compositions of the present invention comprise up to about 20.0% by weight of the total composition of a builder or mixtures thereof, preferably from about 0.1% to about 10.0%, and more preferably from about 0.5% to about 5.0%.

### Radical Scavenger

The compositions of the present invention may comprise a radical scavenger.

Suitable radical scavengers for use herein include the well-known substituted mono and dihydroxy benzenes and their analogs, alkyl and aryl carboxylates and mixtures thereof. Preferred such radical scavengers for use herein include di-tert-butyl hydroxy toluene (BHT), hydroquinone, di-tert-butyl hydroquinone, mono-tert-butyl hydroquinone, tert-butyl-hydroxy anysole, benzoic acid, toluic acid, catechol, t-butyl catechol, benzylamine, 1,1,3-tris(2-methyl-4-hydroxy-5-t-butylphenyl) butane, n-propyl-gallate or mixtures thereof and highly preferred is di-tert-butyl hydroxy toluene. Such radical scavengers like N-propyl-gallate may be commercially available from Nipa Laboratories under the tradename Nipanox S1®.

Radical scavengers, when used, are typically present herein in amounts up to about 10% and preferably from about 0.001% to about 0.5% by weight of the total composition.

The presence of radical scavengers may contribute to the chemical stability of the compositions of the present invention.

### Other Adjuvants

Non-limiting examples of other adjuncts are: enzymes such as proteases, hydrotropes such as sodium toluene sulfonate, sodium cumene sulfonate and potassium xylene sulfonate, and aesthetic-enhancing ingredients such as colorants, providing they do not adversely impact on filming/streaking. The compositions can also comprise one or more colored dyes or pigments. Dyes, pigments and disappearing dyes, if present, will constitute from about 0.1 ppm to about 50 ppm by weight of the aqueous composition.

### Packaging Form of the Compositions

The compositions herein may be packaged in a variety of suitable detergent packaging known to those skilled in the art. The liquid compositions are preferably packaged in conventional detergent plastic bottles.

### EXAMPLES

The following examples are meant to exemplify compositions used in a process according to the present invention but are not intended to limit the scope of the present invention. The liquid compositions below are made by combining the listed ingredients in the order given using the listed proportions to form homogenous mixtures (solution % is by weight of active material).

| | A | B | C | D | E | F | G |
|---|---|---|---|---|---|---|---|
| Alkoxylated | | | | | | | |
| nonionic | | | | | | | |
| surfactants | | | | | | | |
| C 9–11 EO5 | 4.5 | — | 9.0 | 4.0 | 3.0 | — | — |
| C12, 14 EO5 | 1.5 | — | — | 6.0 | 0.5 | 0.7 | — |
| C10 AO7 | — | 3.5 | — | — | — | — | 3.0 |
| C12, 14 EO21 | — | — | — | 2.0 | — | — | — |
| Anionic | | | | | | | |
| surfactants | | | | | | | |
| NaLAS | 0.5 | 0.2 | 0.4 | 1.5 | 0.2 | — | 0.5 |
| Isalchem ® AS | | | | | | 0.4 | |
| NaCS | 1.5 | 0.7 | 1.7 | 3.0 | 1.4 | 0.8 | 0.8 |
| Neutralizing co- | | | | | | | |
| surfactants | | | | | | | |
| C12–14 AO | 0.2 | — | — | — | 0.1 | 0.5 | — |
| Polymers | | | | | | | |
| Copolymer I | 0.1 | — | — | 0.15 | — | 0.075 | — |
| Copolymer II | — | 0.1 | 0.15 | — | 0.05 | — | 0.1 |
| Chelants | | | | | | | |
| DTPMP | 0.1 | 0.1 | 0.2 | — | 0.15 | — | 0.1 |
| Buffer | | | | | | | |
| Na₂CO₃ | 0.2 | 0.4 | 1.0 | 1.0 | 0.6 | — | 0.5 |
| Citric | 1.0 | — | 0.8 | 0.7 | 0.5 | 1.0 | — |
| Caustic | 0.8 | — | 0.3 | 0.4 | 0.3 | 0.7 | — |
| Suds control | | | | | | | |
| Fatty Acid | 0.8 | 0.3 | 0.3 | 0.2 | 0.2 | 0.3 | 0.2 |
| Isofol 12 ® | — | — | — | 0.5 | — | — | — |
| Solvents | | | | | | | |
| EtOH | — | — | — | — | — | — | 1.0 |
| n-BP | — | — | — | — | — | 5.5 | 3.0 |
| MEA | — | — | — | — | — | 0.7 | — |
| Minors and water | up to 100 | | | | | | |
| pH | 9.5 | 9.5 | 9.5 | 9.5 | 10.0 | 11.0 | 9.5 |

Copolymer I derived from Diquat and acrylic acid molar ratio 33/67 prepared by Rhodia
Copolymer II derived from DADMAC and acrylic acid, molar ratio 40/60 prepared by Rhodia
C 9–11 EO5 is a C 9–11 EO5 nonionic surfactant commercially available from ICI or Shell.
C12, 14 EO5 is a C12, 14 EO5 nonionic surfactant commercially available from Huls, A&W or Hoechst.
C10 AO7 is an alkoxylated non-ionic surfactant commercially available from BASF under the tradename Lutensol XL 70 ®.
C12, 14 EO21 is a C12–14 EO21 nonionic surfactant.
NaLAS is Sodium Linear Alkylbenzene sulphonate commercially available from A&W.
NaCS is Sodium Cumene sulphonate commercially available from A&W.
Isalchem ® AS is a C_{12–13} sulphate surfactant commercially available from Enichem.
C12–14 AO is a C12–l4 amine oxide surfactant.
DTPMP is diethylenetriaminepentamethylphosponic acid commercially available from Solutia.
Isofol 12 ® is 2-butyl octanol commercially available from Condea.
n-BP is normal butoxy propanol commercially available from Dow Chemicals.
Ethanol is commercially available from Condea.
MEA is mono-ethanolamine commercially available from Condea.

These liquid compositions are used in a process as disclosed herein and provide good filming and/or streaking performance as well as good shine performance, when used in a dilute/no rinse hard surface cleaning application. In addition, when used in a dilute/no rinse hard surface cleaning application these liquid compositions provide good soil repellency performance as well as good next time cleaning benefit performance.

Furthermore, when used in a neat hard surface cleaning application, these liquid compositions provide good filming and/or streaking performance as well as good shine performance.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process of cleaning a hard surface with a composition comprising a water-soluble or water-dispersible copolymer, said process comprises the steps of applying said composition onto said surface in diluted form and leaving said diluted composition to dry on said surface without rinsing said surface, wherein said water-soluble or water-dispersible copolymer is a water-soluble or water-dispersible copolymer I comprising functionalities with:
a) at least a monomer compound of general formula i: 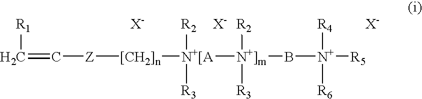
in which:
R₁ is a hydrogen atom, a methyl or ethyl group;
R₂, R₃, R₄, R₅ and R₆, which are identical or different, are linear or branched about C₁-C₆, alkyl, hydroxyalkyl or aminoalkyl groups;
m is an integer from about 0 to about 10;
n is an integer from about 1 to about 6;
Z represents a —C(O)O— or —C(O)NH— group or an oxygen atom;
A represents a (CH₂)ₚ group, p being an integer from 1 to 6;
B represents a linear or branched about C₂-C₁₂, polymethylene chain optionally interrupted by one or more heteroatoms or heterogroups, and optionally substituted by one or more hydroxyl or amino groups;
X⁻, which are identical or different, represent counterions; and
(b) at least one hydrophilic monomer carrying a functional acidic group which is copolymerizable with (a) and which is capable of being ionized in the application medium;
(c) optionally at least one monomer compound with ethylenic unsaturation with a neutral charge which is copolymerizable with (a) and (b), preferably a hydrophilic monomer compound with ethylenic unsaturation with a neutral charge, carrying one or more hydrophilic groups, which is copolymerizable with (a) and (b);
or a water-soluble or water-dispersible copolymer II comprising functionalities with:
d) at least one monomer having the general formula ii: 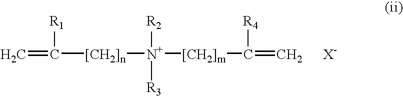
in which:
R₁ and R₄ independently represent H or about a C1-6 linear or branched alkyl group;
R₂ and R₃ independently represent a linear or branched about C1-6 alkyl, hydroxyalkyl or aminoalkyl group, preferably a methyl group;
n and m independently are integers of between about 1 and about 3;
X⁻ represents a counterion;
e) at least one hydrophilic monomer with an acid functionality that is copolymerisable with monomer d) and capable of ionizing in the medium in which it is used; and
f) optionally an ethylenically unsaturated hydrophilic monomer compound of neutral charge bearing one or several hydrophilic groups which is copolymerisable with monomers d) and e), the monomer d) to monomer e) ratio ranging from between about 60:40 and about 5:95;
or a mixture of water-soluble or water-dispersible copolymer I and water-soluble or water-dispersible copolymer II.

2. A process according to claim 1, wherein the monomer (a(i)) is such that
Z represents —C(O)O—, —C(O)NH— or O atom;
n is equal to about 2 or about 3;
m ranges from about 0 to about 2;
B represents —CH2-CH(OH)—(CH₂)_{q}, with q from about 1 to about 4; and
R₁ to R₆, which are identical or different, represent a methyl or ethyl group.

3. A process according to claim 1, wherein said polymer comprises:
(c) at least one monomer compound with ethylenic unsaturation with a neutral charge which is copolymerizable with (a) and (b).

4. A process according to claim 3 wherein (c) is a hydrophilic monomer compound with ethylenic unsaturation with a neutral charge, carrying one or more hydrophilic groups, which is copolymerizable with (a) and (b).

5. A process according to claim 1, wherein (b) is a C₃-C₈ carboxylic, sulphonic, sulfuric, phosphonic or phosphoric acids with monoethylenic unsaturation.

6. A process according to claim 1, wherein the water-soluble or water-dispersible copolymer is obtained by copolymerization of about 3 to about 80 mol %, of the monomer (a); of about 10 to about 95 mol %, of the monomer (b); and about 0 to about 50 mol %, of the monomer (c).

7. A process according to claim 1, wherein the monomers (a) and the monomers (b) have a molar ratio by weight of the total of the monomers (a) to the total of the monomers (b) between about 80/20 and about 5/95.

8. A process according to claim 1, wherein the monomer (d(ii)) is such that
n is equal to about 1;
m is equal to about 1;
X⁻ is preferably chosen from halogen, sulfate, hydrogen sulfate, phosphate, citrate, formate and acetate; and
R₁ represents hydrogen, R₂ represents methyl, R₃ represents methyl, R₄ represents hydrogen.

9. A process according to claim 1, wherein monomer (e) is chosen from about C₃-C₈ carboxylic, sulfonic, sulfuric, phosphonic and phosphoric acids containing monoethylenic unsaturation.

10. A process according to claim 1, wherein monomer (f) is present and is chosen from acrylamide, vinyl alcohol, about C₁-C₄ alkyl esters of acrylic acid and of methacrylic acid, about C₁-C₄ hydroxyalkyl esters of acrylic acid and of methacrylic acid, in particular ethylene glycol and propylene glycol acrylate and methacrylate, polyalkoxylated esters of acrylic acid and of methacrylic acid, in particular the polyethylene glycol and polypropylene glycol esters.

11. A process according to claim 1, wherein the monomer d) to monomer e) molar ratio is between about 50:50 and about 10:90.

12. A process according to claim 1, wherein said compositions comprises water-soluble or water-dispersible copolymer I as said water-soluble or water-dispersible copolymer.

13. A process according to claim 1, wherein said compositions comprises water-soluble or water-dispersible copolymer II as said water-soluble or water-dispersible copolymer.

14. A process according to claim 1, wherein the water-soluble or water-dispersible copolymer is present at a level of from about 0.001% to about 10% of the total weight of said composition.

15. A process according to claim 1, wherein said composition is at least partially left on said surface at the end of said process of cleaning said hard surface, preferably at least partially left on said surface until the next cleaning operation.

16. A process according to claim 1, wherein said composition additionally comprises a surfactant or a mixture thereof.

17. A process according to claim 16 wherein the surfactant is present at a level of from about 0.01% to about 20% by weight of the composition.

18. A process according to claim 16, wherein the weight ratio of water-soluble or water-dispersible copolymer to said surfactant or mixtures thereof is between about 1:100 and about 10:1.

19. A method of providing good filming and/or streaking performance, good shine performance, good soil repellency performance as well as good next time cleaning benefit performance by using a water-soluble or water-dispersible copolymer in a process of cleaning a hard surface with a liquid composition comprising the water-soluble or water-dispersible copolymer herein wherein the said process comprises the steps of applying said composition onto said surface in diluted form and leaving said diluted composition to dry on said surface without rinsing said surface, wherein said water-soluble or water-dispersible copolymer is a water-soluble or water-dispersible copolymer I comprising functionalities with:
a) at least a monomer compound of general formula i: 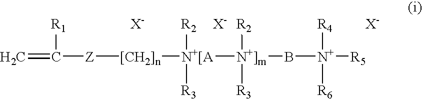
in which:
R₁ is a hydrogen atom, a methyl or ethyl group;
R₂, R₃, R₄, R₅ and R₆, which are identical or different, are linear or branched about C₁-C₆, alkyl, hydroxyalkyl or aminoalkyl groups;
m is an integer from about 0 to about 10;
n is an integer from about 1 to about 6;
Z represents a —C(O)O— or —C(O)NH— group or an oxygen atom;
A represents a (CH₂)ₚ group, p being an integer from about 1 to about 6;
B represents a linear or branched about C₂-C₁₂, polymethylene chain optionally interrupted by one or more heteroatoms or heterogroups, and optionally substituted by one or more hydroxyl or amino groups;
X⁻, which are identical or different, represent counterions; and
(b) at least one hydrophilic monomer carrying a functional acidic group which is copolymerizable with (a) and which is capable of being ionized in the application medium;
(c) optionally at least one monomer compound with ethylenic unsaturation with a neutral charge which is copolymerizable with (a) and (b), preferably a hydrophilic monomer compound with ethylenic unsaturation with a neutral charge, carrying one or more hydrophilic groups, which is copolymerizable with (a) and (b); or
or a water-soluble or water-dispersible copolymer II comprising functionalities with:
d) at least one monomer having the general formula ii: 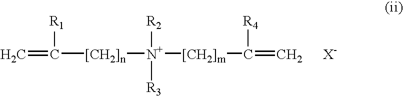
in which:
R₁ and R₄ independently represent H or about a C1-6 linear or branched alkyl group;
R₂ and R₃ independently represent a linear or branched about C1-6 alkyl, hydroxyalkyl or aminoalkyl group, preferably a methyl group;
n and m independently are integers of between about 1 and about 3;
X⁻ represents a counterion; and
e) at least one hydrophilic monomer with an acid functionality that is copolymerisable with monomer d) and capable of ionizing in the medium in which it is used; and
f) optionally an ethylenically unsaturated hydrophilic monomer compound of neutral charge bearing one or several hydrophilic groups which is copolymerisable with monomers d) and e), the monomer d) to monomer e) ratio ranging from between about 60:40 and about 5:95;
or a mixture of water-soluble or water-dispersible copolymer I and water-soluble or water-dispersible copolymer II.

20. A method of providing good filming and/or streaking performance as well as good shine performance by using a water-soluble or water-dispersible copolymer in a process of cleaning a hard surface with a liquid composition comprising the water-soluble or water-dispersible copolymer herein wherein the process comprises the step of applying said composition in its neat form onto said hard surface, wherein said water-soluble or water-dispersible copolymer is a water-soluble or water-dispersible copolymer I comprising functionalities with:
a) at least a monomer compound of general formula i: 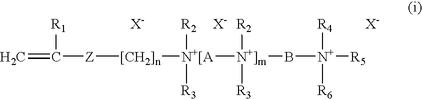
in which:
R₁ is a hydrogen atom, a methyl or ethyl group;
R₂, R₃, R₄, R₅ and R₆, which are identical or different, are linear or branched about C₁-C₆, alkyl, hydroxyalkyl or aminoalkyl groups;
m is an integer from about 0 to about 10;
n is an integer from 1 to 6;
Z represents a —C(O)O— or —C(O)NH— group or an oxygen atom;
A represents a (CH₂)ₚ group, p being an integer from about 1 to about 6;
B represents a linear or branched about C₂-C₁₂, polymethylene chain optionally interrupted by one or more heteroatoms or heterogroups, and optionally substituted by one or more hydroxyl or amino groups;
X⁻, which are identical or different, represent counterions; and
(b) at least one hydrophilic monomer carrying a functional acidic group which is copolymerizable with (a) and which is capable of being ionized in the application medium;
(c) optionally at least one monomer compound with ethylenic unsaturation with a neutral charge which is copolymerizable with (a) and (b), preferably a hydrophilic monomer compound with ethylenic unsaturation with a neutral charge, carrying one or more hydrophilic groups, which is copolymerizable with (a) and (b); or
or a water-soluble or water-dispersible copolymer II comprising functionalities with:
d) at least one monomer having the general formula ii: 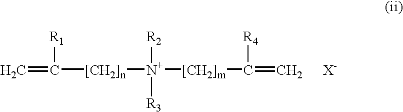
in which:
R₁ and R₄ independently represent H or about a C1-6 linear or branched alkyl group;
R₂ and R₃ independently represent a linear or branched about C1-6 alkyl, hydroxyalkyl or aminoalkyl group, preferably a methyl group;
n and m independently are integers of between about 1 and about 3;
X⁻ represents a counterion;
e) at least one hydrophilic monomer with an acid functionality that is copolymerisable with monomer d) and capable of ionizing in the medium in which it is used; and
f) optionally an ethylenically unsaturated hydrophilic monomer compound of neutral charge bearing one or several hydrophilic groups which is copolymerisable with monomers d) and e), the monomer d) to monomer e) ratio ranging from between about 60:40 and about 5:95;
or a mixture of water-soluble or water-dispersible copolymer I and water-soluble or water-dispersible copolymer II.
